(19) United States
(12) Patent Application Publication
(10) Pub. No.: US 2003/0063751 A1
(43) Pub. Date: Apr. 3, 2003

(54) Key agreement protocol based on network dynamics

(76) Inventors: Aiden Bruen, Calgary (CA); Mario Forcinito, Calgary (CA); David Wehlau, Kingston (CA)

Correspondence Address: STEVENS DAVIS MILLER & MOSHER, LLP, 1615 L STREET, NW, SUITE 850, WASHINGTON, DC, 20036, US

(21) Appl. No.: 10/245,502

(22) Filed: Sep. 18, 2002

(30) Foreign Application Priority Data
Sep. 20, 2001 (IE) S2001/0842

(51) Int. Cl. H04L 9/00

(52) U.S. Cl. 380/278

(57) ABSTRACT

A system and method for an unconditionally secure protocol to create identical pads or keys between two parties communicating over any network is provided. The protocol is composed of three parts, as follows. Firstly, the two parties generate an initial correlated string Ka, Kb by simultaneously observing common physical phenomena such as a satellite signal or recording round trip timing of messages being rallied back and forth, etc. Secondly, the two parties engage in Information Consolidation and Reconciliation in order to reconcile differences. Finally, Privacy Amplification is used to cancel any information that an eavesdropper may have acquired and to produce the key or pad. This key agreement protocol creates unconditionally secure cryptography with a symmetric key cryptosystem. Alternatively, the symmetric keys can be used as a one-time pad with unconditional security.

### RELATED APPLICATIONS

This Application relates to our corresponding Application (Attorney Docket No. TPP 31463) filed on the same date and entitled “Method For The Construction Of Hash Functions Based On Sylvester Matrices, Balanced Incomplete Block Designs, and Error-Correcting Codes” naming Aiden BRUEN, David WEHLAU and Mario FORCINITO as the inventors.

### BACKGROUND OF THE INVENTION

1. Field of the Invention

The present invention relates to cryptographic systems. More particularly, the invention generates, by public discussion, a cryptographic key that is unconditionally secure. Prior to this invention, cryptographic keys generated by public discussion, such as Diffie-Hellman, satisfied the weak condition of computational security but were not unconditionally secure.

2. Discussion of the Related Art

An Achilles heel of classical cryptographic systems is that secret communication can only take place after a key is communicated in secret over a totally secure communication channel. Lomonaco [5,6] describes the matter as the “Catch 22” of cryptography, as follows:

“Catch 22. Before Alice and Bob can communicate in secret, they must first communicate in secret.”

Lomonaco goes on to describe further difficulties involving the public key cryptographic systems that are currently in use. For a discussion on several other disadvantages of the Public Key Infrastructure (PKI) see U.S. General Accounting Office Report [8] and Schneier [13].

Let x be a common key that has been created for Alice and Bob. That is, x is a binary vector of length n. Then x can be used as a one-time pad as follows. Let m be a message that Alice wishes to transmit to Bob: m is some binary vector also of length n. Alice encodes m as m⊕x where ⊕ denotes bitwise addition, i.e., exclusive OR. Thus m⊕x, not m, is broadcast over the public channel. Bob then decodes in exactly the same way. Thus Bob decodes the message (m⊕x)⊕x, which is m, because of the properties of bitwise addition.

Alternatively, the key x can be used in a standard symmetric key cryptosystem such as that of Rijndael [12] or Data Encryption Standard (DES) [13]. The idea now is to encode m as fₓ(m) where fₓ denotes the Rijndael permutation with the parameter x. Then, to get the message, Bob decodes by gₓ[fₓ(m)]=m where gₓ is the inverse of fₓ.

To date, practical protocols for constructing such a common key x use for their security unproven mathematical assumptions concerning the complexity of various mathematical problems such as the factoring problem, the discrete log problem, and the Diffie-Hellman problem. Another serious difficulty concerning present systems involves the very long keys that are needed for even minimal security. In his monograph R. A. Mollin [17] points out that for elliptic curves cryptography an absolute minimum of 300 bits should be used for even the most modest security requirements and 500 bits for more sensitive communication. Further, key lengths of 2048 bits are recommended for RSA in the same reference.

In [19] chapter 5, Julian Brown gives an example of a financial encryption system depending on RSA keys of 512-bit, namely the CREST system introduced in 1997 by the Bank of England. He quotes the noted cryptographer A. Lenstra concerning such codes as follows: “Keys of 512 bits might even be within the reach of cypherpunks. In principle they could crack such numbers overnight”.

Randomness in Arrival Times of Network Communications

Computer networks are very complex systems formed by the superposition of several protocol layers [14]. FIG. 1 shows the layers in a typical network. The following analysis of how the layers work together serves to explain the randomness in networks.

The lowest layer connects two computers, i.e., creates a channel between them, by some physical means and is called the Physical Layer.

The second layer removes random physical errors (called “noise”) from the channel to create an error-free communications path from one point to another. This layer, i.e., the Data Link Layer, is primarily responsible for dealing with transmission errors generated as electrical impulses (representing bits) as sent over a physical connection. Error detection techniques [15] are used to identify the transmission errors in many protocols. Once an error is detected the protocol requests a resend. Random errors in the Data Link Layer can be observed by noting timing delays.

The Medium Access Layer deals with allocating and scheduling all communications over a single channel. In a networked environment, including the Internet, many computers communicate over a single channel. Bursts in packet traffic is a well-known characteristic and is due to the uncontrollable behavior of many individual computers communicating over a single channel [16] leading to random fluctuations in transmission times.

The Network Layer deals with routing information to create a true or virtual connection between two computers. The routing is dependent on the variety of routing algorithms and the load placed on each router. These two factors makes the transmission times fluctuate randomly.

The Transport Layer interfaces with the final Application Layer to provide an end-to-end, reliable, connection-oriented byte stream from sender to receiver. To do so, the Transport Layer provides connection establishment and connection management. The times associated with Transport layer activities depend on all devices in the network and the algorithms being used. Thus, fluctuations in transmission times in the Transport Layer also occur, contributing to timing delays.

However, not only the network influences timing fluctuations. The transmitting and receiving computers have internal delays resulting from servicing network packets. Thus, even the act of observing the timings will also introduce random fluctuations. (See appendix B for an analysis of the effects of perturbations on arrival timing).

### SUMMARY OF THE INVENTION

The present invention provides an efficient, practical system and method for a key agreement protocol based on network dynamics that has the strongest possible security, namely, unconditional security, and that does not require any additional hardware. Previous work in this area is either theoretical [11] or practically infeasible due the requirement for additional channels based on expensive and complicated hardware such as satellites, radio transmitter arrays and accompanying additional computer hardware to communicate with these devices [7]. All previous cryptographic keys only satisfy the weaker criterion of computational security.

The present invention introduces relative time sequences based on round-trip timings of packets between two communicating parties. These packets form the basic building blocks for creating an efficient and unconditionally secure key agreement protocol that can be used as a replacement for current symmetric and asymmetric key cryptosystems. The present invention is an unconditionally secure cryptographic system and method based on ideas that can be used in the domain of quantum encryption [1, 5 and 20 Chapter 6]. Moreover, the present invention for the first time provides a cryptographic protocol that exploits fundamental results (and their interconnectedness) in the fields of information theory, error-correction codes, block design and classical statistics. The system and method of the present invention is computationally faster, simpler and more secure than existing cryptosystems. In addition, due to the unconditional security provided by the present invention, the system and method of the present invention are invulnerable to all attacks from super-computers and even quantum computers. This is in sharp contrast to all previous protocols.

The present invention provides a protocol that uses two characteristics of network transit time: namely, its randomness, and the fact that, despite this, the average timing measured by two communicating parties will converge over a large number of repetitions. The result is that two correlated random variables are obtained by measuring the relative time a packet takes to complete a round trip with respect to a first party, Alice or A, and a round trip with respect to a second party, Bob or B.

In a preferred embodiment, A and B engage in rallying packets back and forth and calculateround-trip times individually. The packets may be used for any additional purpose since the contents of the packets are irrelevant. Only the round-trip times are of interest. FIG. 2 shows one round of a relative round-trip time generator of the present invention. FIG. 2 diagrammatically describes the process.

PHASE 1—Alice and Bob employ the system and method of the present invention to construct a permuted remnant bit string from a sequence of observed packet round-trip times:

Alice and Bob exchange packets over a network, record round-trip times, and each form a bit string by concatenating a pre-arranged number of low order bits of successive packet round-trip times. Once sufficient bits are concatenated, the process is stopped and both Alice and Bob apply a pre-determined permutation to their respective concatenated bit strings to form permuted remnant raw keys K_{A} and K_{B}, respectively of equal lenght.

PHASE 2—Alice and Bob employ these remnant raw keys to create a reconciled key:

Alice and Bob systematically partition their respective permuted remnant raw keys, K_{A} and K_{B}, into sub-blocks, compute, exchange and compare parities for each sub-block, and, discarding the low order bit of the sub-block, re-concatenate the modified sub-blocks in their original order. In the case of blocks with mismatched parities the partition process is iterated until mismatched bits are located and deleted.

PHASE 3—Alice and Bob create an unconditionally secure pad or key from their common reconciled key:

Privacy amplification to eliminate any partial information that an eavesdropper, Eve, might have is applied by both Alice and Bob using a pre-determined proprietary hash function [4] to produce a final unconditionally secure key of a pre-determined length from the reconciled key.

### BRIEF DESCRIPTION OF THE DRAWINGS

FIG. 1 illustrates a typical multi-layer computer network protocol.

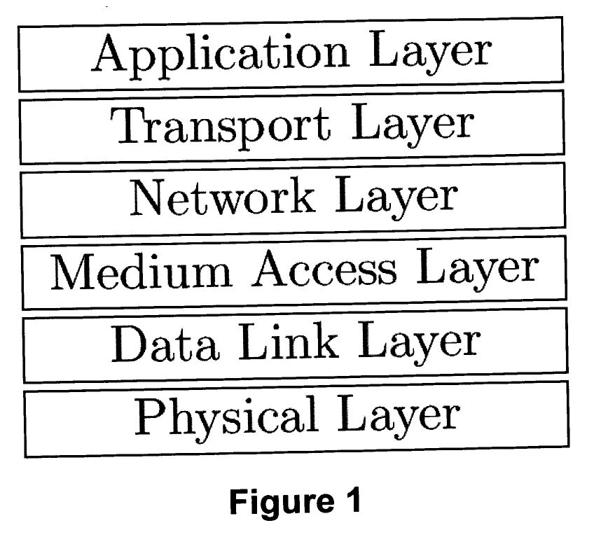

FIG. 2 illustrates one rallying round between two communicating parties for generating a permuted remnant bit string by each party.

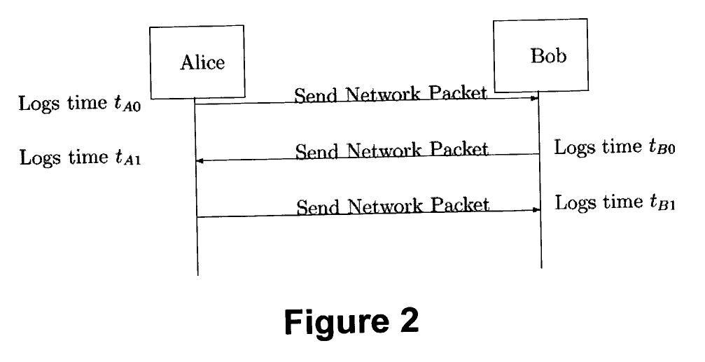

FIG. 3 illustrates mean arrival time as a function of channel noise (noise parameter).

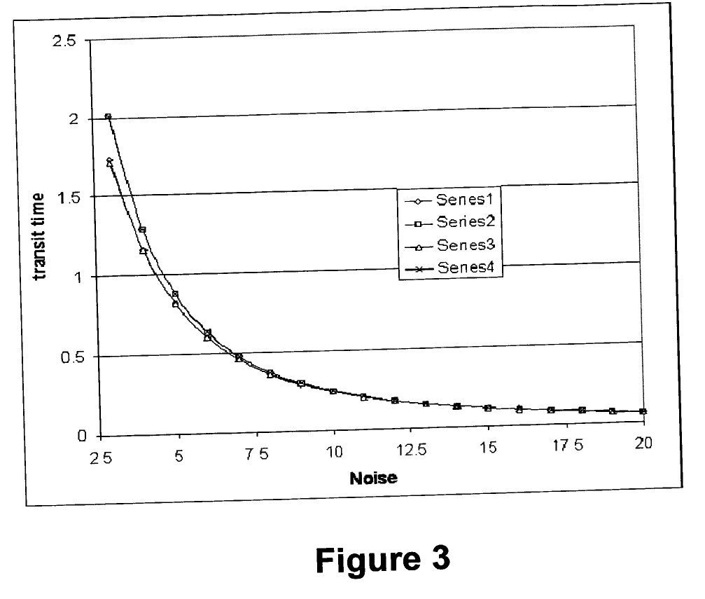

### DETAILED DESCRIPTION OF THE INVENTION

In a preferred embodiment, the key agreement scheme of the present invention comprises three phases. The first phase is construction of a permuted remnant bit string wherein the two communicating parties, Alice and Bob, rally packets back and forth recording round-trip times. Some of the bits may still be different after the initial bit string construction so Alice and Bob then participate in a second phase called Information Reconciliation. The second phase results in Alice and Bob holding exactly the same key. However, Eve may have partial knowledge of the reconciled strings, in the form of Shannon bits. Therefore, a third and final phase called Privacy Amplification is performed to eliminate any partial information collected by Eve.

PHASE I—Alice and Bob rally packets back and forth to generate a bit string from truncated round-trip timings. This string is then systematically permuted. The procedure is as follows:

(i) Alice sends Bob a network packet and logs the time t_{A0}.

(ii) Bob records the time of reception as t_{B0} and responds immediately to Alice with another network packet.

(iii) Alice records the time of reception as t_{A1}, and responds immediately with a network packet.

(iv) Bob records the time of reception as t_{B1} and responds immediately to Alice with another network packet.

(v) Alice and Bob respectively calculate

Δt_{A}=t_{A1}−t_{A0}

and

Δt_{B}=t_{B1}−t_{B0}

Depending on the quality of the network connection, only some bits of Δt_{A} and Δt_{B} are kept. The higher order bits are dropped. Typical experimental data and criteria for the truncation can be found in [18].

By taking a suitable probability distribution it can be shown that the average of Δt_{A} equals the average of Δt_{B}.

(vi) Repeat steps (i) through (v) in order to create enough bits which are then concatenated as a string of bits of a predetermined length.

PHASE II—Once sufficient bits are created, the process is stopped. Alice and Bob must now use the relative time series to create an unconditionally secure pad or key. One skilled in the art can deduce, from a study of various papers in the list of references that there are many ways to proceed. The present invention uses an approach which, very loosely speaking, is initially related to that of Bennett et al.[1]. However in [3, 4 and 10], several changes and improvements have been indicated. These changes, based on fundamental results in algebraic coding theory, information theory, block design and classical statistics together achieve the following results:

(a) an a-priori bound on key-lengths;

(b) a method for estimating the initial and subsequent bit correlations and key-lengths;

(c) a precise procedure on how to proceed optimally at each stage;

(d) a formal proof that K_{A} converges to K_{B};

(e) a stopping rule;

(f) a verification procedure for equality; and

(g) a new systematic hash function for Privacy Amplification.

After PHASE I, Alice and Bob have their respective binary arrays K_{A} and K_{B} and both perform the following steps of PHASE II:

(vii) Shuffle and partition. Alice and Bob apply a permutation to K_{A} and K_{B}. They then partition the remnant raw keys into sub-blocks of length l=4.

(viii) Parity exchange and bisective search with l=4: Parities are computed and exchanged for each sub-block of length 4 by Alice and Bob. Simultaneously they discard the bottom bit of each sub-block so that no new information is revealed to Eve. If the parities agree Alice and Bob retain the three top bits of each sub-block. If the parities disagree Alice and Bob perform a bisective search discarding the bottom element in each sub-block exactly as described in [1] and [5] (see also [4]). The procedure in steps (vii) and (viii) is denoted by KAP₄.

(ix) Estimate Correlation From the length of the new key, we can calculate the expected initial bit correlation x₀ between K_{A} and K_{B} [4]. Using x₀ we can calculate the present expected correlation x=φ₄(x₀).

(x) Shuffle, parity exchange, bisective search with the optimal l: To the remnant keys K_{A}, K_{B} we apply a permutation f in order to separate adjacent keys. As a non-restrictive example, one such f can be implemented by shuffling the bit order from (1, 2, 3, . . . , n) into the order (1, p+1, 2p+1, . . . , q₁p+1, 2, p+2, 2 p+2, . . . , q₂p+2, . . . , p−1, 2 p−1, 3 p−1, . . . , qₚ₋₁p+p−1, p, 2 p, 3 p, qₚp+p), where qᵢ=(n−i)/p.

Given the present correlation x we choose the optimal value for l=l(x) by using the tables in [4]. Similar to (viii), (ix) for the case l=4, we carry out the procedure KAPₗ. From x, or from the new common length of the remnant keys, we calculate the expected present correlation after KAPₗ has been applied. We repeat (xi) until the stopping condition holds.

(xi) Stopping Condition : For key length n and correlation x we have n(1−x)<ε, a predetermined small positive number. We then proceed to the verification procedure, an example of which is as follows.

(xii) Verification Procedure: Let K_{A}, K_{B} both be of length n. Let t be the smallest integer for which 2^{t}≦n. Construct a binary matrix M=mᵢⱼ, (1≦i≦t+1, 1≦j≦2^{t}) as follows:

a. The entries mᵢⱼ, (1≦i,j≦t ) are the entries of the t×t identity matrix I_{t×t}.

b. The (t+1)^{th} row of M is the all-ones vector, that is m_{t+1,j}=1(1≦j≦2^{t}).

c. Denote the top t entries in the j^{th} column by the binary vector vⱼ (1≦j≦2^{t}) Thus, vj={mᵢⱼ|1≦i≦t}. Then we impose the condition that the vectors vⱼare all distinct. Thus, the set {vⱼ} equals the set of all 2^{t} distinct binary vectors of length t.

d. Denote the rows of M by R₁, R₂, . . . , Rₜ₊₁. Let x, y denote the remnant keys K_{A}, K_{B} written as row vectors of length n. Let x, y denote the vectors that result when a row of zeros of length 2^{t}−n is adjoined, on the right of x, y respectively. Thus x=(x,000 . . . 0), y=(y,000 . . . 0).

e. Our verification criterion is to check that x.Rᵢ=y.Rᵢ, (1≦i≦t+1).

If the verification criterion is not satisfied we remove the first t+1 bits from K_{A}, K_{B} and repeat steps (x), (xi) and check again if the verification criterion is satisfied. Eventually, it will be satisfied.

At this stage Alice and Bob have confirmed that they now share the same key. Once confirmed, the final remnant raw key as transformed by Phase 2 is modified by removing the first t+1 bits from K_{A}=K_{B}. Our new key is re-named the “reconciled key” and phase 3, Privacy amplification is performed.

PHASE III—At this stage Alice and Bob now have a common reconciled key. In certain cases it is possible that the key is only partially secret to eavesdropper, Eve, in the sense that Eve may have some information on the reconciled key in the form of Shannon bits. Alice and Bob now begin the process of PrivacyAmplification that is the extraction of a final secret key from a partially secret one (see [1] and [2]). A well-known result of Bennett, Brassard and Robert (see [18]) shows that Eve's average information about the final secret key is less than 2^{-s}/ln 2 Shannon bits as explained below (See also Shannon [9]).

(xiii) Privacy Amplification—Let the upper-bound on Eve's number of Shannon Bits be k and let s>0 be some security parameter that Alice and Bob may adjust as desired. Alice and Bob now apply a hash function described in “Method For The Construction Of Hash Functions Based On Sylvester Matrices, Balanced Incomplete Block Designs And Error-Correcting Codes”, co-pending Irish Patent Application, (the entire contents of which is hereby included by reference as if fully set forth herein [3]) which produces a final secret key of length n-k-s from the reconciled key of length n.

The system and method of the present invention provide an unconditionally secure key agreement scheme based on network dynamics as follows. In PHASE I, Alice and Bob permute the bits of what remains of their respective raw keys, which keys incorporate delay occasioned by network noise. In PHASE II, the key from PHASE I undergoes the treatment of Lomonaco [5]. That is, in PHASE II Alice and Bob partition the remnant raw key into blocks of length l. An upper bound on the length of the final key has been estimated and the sequence of values of l that yield key lengths arbitrarily close to this upper bound has also been estimated [4]. In PHASE II, for each of these blocks, Alice and Bob publicly compare overall parity checks, making sure each time to discard the last bit of the compared block. Each time an overall parity check does not agree, Alice and Bob initiate a binary search for the error, i.e., bisecting the mismatched block into two sub-blocks, publicly comparing the parities for each of these sub-blocks, while discarding the bottom bit of each sub-block. They continue their bisective search on the sub-block for which their parities are not in agreement. This bisective search continues until the erroneous bit is located and deleted. They then proceed to the next l-block.

PHASE I is then repeated, i.e., a suitable permutation is chosen and applied to obtain the permuted remnant raw key. PHASE II is then repeated, i.e., the remnant raw key is partitioned into blocks of length l, parities are compared, etc. Precise expressions for the expected bit correlation (see below) following each step have been obtained in [4], where it is also shown that this correlation converges to 1. Moreover in [4] the expected number of steps to convergence as well as the expected length of the reconciled key are tabulated.

The probability that corresponding bits agree in the arrays K_{A}, K_{B} is known as the bit correlation probability or, simply, as the bit correlation. It can be shown (see [4]) that each round can be used to increase the bit-correlation. For example, if we start with a bit-correlation of 0.7 then after one round with l=3 the bit-correlation increases to about 0.77 and then to 0.87. For l=2 the corresponding numbers are 0.84 and 0.97. Estimates are also available for the key lengths after a round of the protocol of the present invention, for various values of l[4].

The final secret key can now be used for a one-time pad to create perfect secrecy or can be used as a key for a symmetric key cryptosystem such as Rijndael [12] or Triple DES [18].

A simplified version of the algorithm for the values l=2 and 3 is described in Appendix A.

It will be understood by those skilled in the art, that the above-described embodiments are but examples from which it is possible to deviate without departing from the scope of the invention as defined in the appended claims.

### REFERENCE AND BIBLIOGRAPHY

The following references are hereby incorporated by reference as if fully set forth herein.

[1] Charles Bennett, Francois Bessette, Gilles Brassard, Louis Salvail, and John Smolin, Experimental quantum cryptography, EUROPCRYPT '90 (Arhus, Denmark), 1990, pp. 253-265.

[2] Charles H. Bennett, Gilles Brassard, and Jean-Marc Robert, Privacy Amplification by Public Discussion, Siam J. of Computing, 17, no.2 (1988), pp.210-229.

[3] Aiden Bruen and David Wehlau, Method for the Construction of Hash Functions Based on Sylvester Matrices, Balanced Incomplete Block Designs, and Error-Correcting Codes, Irish Patent Co-pending Irish Patent Application.

[4] Aiden Bruen and David Wehlau, A Note On Bit-Reconciliation Algorithms, Non-Elephant Encryption Systems Technical Note 01.xx NE2, 2001.

[5] Samuel J. Lomonaco, A quick glance at quantum cryptography, Cryptologia 23 (1999), no. 1, pp. 1-41.

[6] ______, A Rosetta Stone for Quantum Mechanics With An Introduction to Quantum Computation, quant-ph/0007045 (2000).

[7] Ueli M. Maurer, Secret Key Agreement By Public Discussion From Common Information, IEEE Transactions on Information Theory 39 no.3 (1993), pp. 733-742.

[8] United States General Accounting Office, Advances and Remaining Challenges to Adoption of Ppublic Key Infrastructure Technology, GAO 01-227 Report, February 2001, Report to the Chairman, Subcommittee on Government Efficiency, Financial Management and Intergovernmental Relations, Committee on Government Reform, House of Representatives.

[9] Claude E. Shannon, Communication Theory of Secrecy Systems, Bell System Technical Journal 28(1949), 656-715.

[10] David Wehlau, Report for Non-Elephant Encryption, Non-Elephant Encryption Technical Note Jan. 8, 2001.

[11] A. D. Wyner, The Wire-Tap Channel, Bell System Technical Journal 54 no.8(1975), 1355-1387.

[12] Joan Daemon and Vincent Rijnmeien, The Rijndael Block Cypher, June 1998, http://csrc.nist.gov/encryption/aes/rijndael/rijndael.pdf

[13] Bruce Schneier, Applied Cryptography, 2^{nd} Edition, John Wiley & Sons, New York, 1996, Chapter 12.

[14] Andrew Tanenbaum, Computer Networks, Prentice Hall, 1996.

[15] Claude E. Shannon, A Mathematical theory of Communication, Bell System Technical Journal 27(1948), pp. 379-423and 623-656.

[16] Will E. Leland, Murad S. Taqq, Walter Willinger, and Daniel V. Wilson, On the Self-Similar Nature of Ethernet Traffic, Proc. SIGCOMM (San Francisco, Calif.; Deepinder P. Sidhu, Ed.), 1993, pp. 183-193.

[17] R. A. Mollin, An Introduction to Cryptography, Chapman & Hall/CRC, 2000. Chapter 6.

[18] Douglas R. Stinson, Cryptography. Theory and Practice, CRC Press, 1995.

[19] Julian R. Brown, The Quest for the Quantum Computer, Simon & Schuster, New York, 2001.

[image]

[image]

We claim:

1. A method of generating an unconditionally secure cryptographic key between a first and a second cryptographic station A and B, said method comprising the steps of:
a) in said first and second station A and B, constructing, in a pre-arranged way from an independently recorded measurement of a given physical phenomena, a first and second correlated string L_{A}, L_{B} each of a given length N (i.e., said first and second string L_{A}, L_{B} constructed such that the corresponding statistical variables are not independent) of digits selected from a finite alphabet;
b) in said first and second station A and B, applying a predetermined permutation g=g_{N} to L_{A}, L_{B} to obtain a first and second permuted string g(L_{A}) and g(L_{B}), wherein g=g_{H} is a pre-determined permutation and then expressing g(L_{A}), g(L_{B}) as a pre-determined concatenation U₁(=S_{A}), U₂, . . . , Uₘ and V₁(=S_{B}), V₂, . . . , V_{m′} respectively wherein S_{A} is a substring of said first permuted string g(L_{A}), S_{B} is a substring of said second permuted string g(L_{B}), and the length of Uᵢ equals the length of Vᵢ for 1≦i≦m;
c) evaluating recursively P(S_{A},S_{B})=Pₗ(S_{A},S_{B}) wherein l=|S_{A}|=|S_{B}| is the common length of S_{A} and S_{B}, and P is a function defined on certain ordered pairs (U,V) of strings U, V having a common length s=|U|=|V|, said evaluating step further comprising the substeps of;
(i) in said first station A, transmitting to said second station B, the computed value Γ(S_{A}), of a predetermined function Γ on S_{A}, wherein Γ is a function mapping strings to strings that maps the null string to the null string having the property that for strings X,Y with |X|=|Y|, Γ(X)=Γ(Y)− and transmitting said value to station B;
(ii) in said second station B, transmitting to said first station A the digit 1 if Γ(S_{A}) is equal to the computed value Γ(S_{B}) and the digit 0 otherwise;
(iii) in said first and second station A and B, respectively, calculating strings f(S_{A}), f(S_{B}) wherein f is a pre-assigned function mapping strings to strings that maps the null string to the null string, maps all strings of length one to the null string and is such that for any string X the length of f(X) is less than or equal to the length of X and having the property that for strings X,Y with |X|=|Y|, |f(X)|=|f(Y)|;
(iv) in said first and second station A and B, setting Pₗ(S_{A},S_{B})=(f(S_{A}),f(S_{B})) in the case when Γ(S_{A})=Γ(S_{B});
(v) when Γ(S_{A})≠Γ(S_{B}), performing the substeps of:
a. in said first station A, writing f(S_{A}) as a concatenation M_{A} N_{A} of strings M_{A}, N_{A} having λ=|N_{A}|=½t or ½t+1/2(when t is even or odd respectively) where t is the common length of f(S_{A}), f(S_{B}),
b. in said second station B, writing f(S_{B}) as a concatenation M_{B} N_{B} of strings M_{B}, N_{B} having λ=|N_{A}|=|N_{B}|;
(vi) in said first station A, transmitting Γ(N_{A}) to said second station B;
(vii) in said second station B, transmitting to said first station A the digit 1 if Γ(N_{A})=Γ(N_{B}) and the digit 0 otherwise;
(viii) setting Pₗ(S_{A},S_{B})=(X₁,Y₁) in the case when Γ(N_{A})=Γ(N_{B}) wherein X₁ is a concatenation of the first component of P_{t-λ}(M_{A},M_{B}) with the string f(N_{A}) and Y₁, is a concatenation of the second component of P_{t-λ}(M_{A}, M_{B}) with f(N_{B});
(ix) setting Pₗ(S_{A},S_{B})=(X₂,Y₂) in the case when Γ(N_{A})≠Γ(N_{B}), where X₂ is a concatenation of MA with the first component of P_{λ}(N_{A},N_{B}) and Y₂ is the concatenation of M_{B} with the second component of P_{λ}(N_{A},N_{B}).
(x) recursively calculating P_{λ}(N_{A},N_{B}), (or P_{t-λ}(M_{A},M_{B})) by repetition of sub-steps (i) to (ix) with S_{A}=N_{A}, S_{B}=N_{B}(or S_{A}=M_{A}, S_{B}=M_{B}) thereby obtaining Pₗ(S_{A},S_{B}).
d) calculating successively Pₗᵢ(Uᵢ,Vᵢ) with lᵢ=|Uᵢ|=|Vᵢ| by repeating step (c) with S_{A}=Uᵢ, S_{B}=Vᵢ and then concatenating W₁, W₂, W₃, . . . Wₘ to construct a first concatenated string K_{A} in said station A where W₁ is the first component of the pair Pₗ(Uᵢ,Vᵢ)=Pₗ(S_{A},S_{B}) and Wᵢ is the first component of the pair Pₗ(Uᵢ,Vᵢ), 2≦i≦m;
e) calculating successively Pₗᵢ(Uᵢ,Vᵢ) with lᵢ=|Uᵢ|32 |Vᵢ| by repeating step (c) with S_{A}=Uᵢ, S_{B}=Vᵢ and then concatenating the strings Z₁, Z₂, Z₃, . . . Zₘ to construct a second concatenated string K_{B} of length n in said station B where Z₁ is the second component of the pair Pₗ(U₁,V₁)=Pₗ(S_{A},S_{B}) and Zᵢ is the second component of the pair Pₗ(Uᵢ,Vᵢ), with lᵢ=|Uᵢ|=|Vᵢ|, 2≦i≦m;
f) from |K_{A}|=|K_{B}| calculating a bit correlation x=x(K_{A},K_{B}) from a predetermined formula using the length n=|K_{A}|=|K_{B}| wherein K_{B} is replaced by a Boolean complement K_{B}* (obtained by replacing 1 and 0 in K_{B} by 0 and 1 respectively) whenever the bit correlation between K_{A} and K_{B} is less than 0.5, yielding x>0.5;
g) determining whether x(K_{A},K_{B}) satisfies a pre-determined stopping inequality S;
h) repeating steps (b) to (g) with L_{A}=K_{A}, L_{B}=K_{B} in the case that S is not satisfied;
i) otherwise in the event that inequality S is satisfied, performing the substeps of;
(i) evaluating C(K_{A}) in said first station A where C is a pre-determined hash function defined on all non-null strings;
(ii) in said first station A, transmitting C(K_{A}) to said second station B;
(iii) evaluating C(K_{B}) in said second station B;
(iv) in said second station B, transmitting to said first station A a digit 1 if C(K_{B})=C(K_{A}) and a digit 0 otherwise;
j) in the event that C(K_{A}) C(K_{B}), constructing Λ(K_{A})=Λ(K_{B}), an unconditionally secure cryptographic key shared by said first and second cryptographic stations A and B, wherein Λ is a pre-determined hash function that eliminates all of an eavesdropper's potential information; and
k) repeating steps (b) to (j) in the event that C(K_{A}) C(K_{B}), wherein L_{A}=K_{A} and L_{B}=K_{B}, respectively.

2. A method of generating an unconditionally secure cryptographic key between a first and second cryptographic station A and B according to claim 1, wherein step a) further comprises the substeps of:
a.1) respectively providing said first and second station A and B a first secret string R₁ and a second secret string R₂, R₁ and R₂ being correlated (i.e., the statistical variables corresponding to R₁ and R₂ are not independent) and having the same length; and
a.2) respectively replacing said first and second string L_{A}and L_{B} with said first and second secret string Rₗand R₂.

3. A method of generating an unconditionally secure cryptographic key between a first and second cryptographic station A and B, said method comprising the method of claim 2, wherein said secret strings R₁ and R₂ are obtained from the bounded storage model (of Maurer and Rabin).

4. The method of claim 1, wherein said predetermined hash function C of step i) is the syndrome of a binary linear code of minimum distance d wherein d is some predetermined positive integer.

5. The method of claim 1, wherein step a) further comprises the substeps of:
a.1) in said first and second station A and B, respectively concatenating a generated first and second random string R_{A} and R_{B} with said first and second string L_{A} and L_{B} to result in a first and second concatenated string L_{A}R_{A} and L_{B}R_{B}; and
a.2) in said first and second station A and B, respectively substituting said first concatenated string L_{A}R_{A} for said first string L_{A} and said second concatenated string L_{B}R_{B} for said second string L_{B}.

6. The method of claim 2, wherein the strings R₁ and R₂ are replaced by the concatenated strings R₁ R_{A}, R₂ R_{B} respectively wherein R_{A} is a random string generated in station A and R_{B} is a random string generated in station B with R_{A} and R_{B} having the same length.

7. The method of claim 1, wherein step a) further comprises the substep of in said first and second station A and B, respectively, replacing said first and second string L_{A} and L_{B} with the dot product modulo 2 of a generated first and second random binary string R_{A} and R_{B} with said first and second string L_{A} and L_{B} to form a first and second dot product string L_{A}•R_{A} and L_{B}•R_{B}, wherein R_{A} and R_{B} are generated random binary strings having the same length as L_{A} and L_{B}, respectively.

8. The method of claim 2, wherein the strings R₁ and R₂ are replaced by the strings R₁•R_{A}, R₂ •R_{B}, respectively, wherein R_{A} is a random string generated in station A and R_{B} is a random string generated in station B with R_{A} and R_{B} having the same length as R₁ and R₂, respectively.

9. A method of generating a first and second string U and V in first and second station A and B, respectively, said first and second string U and V having a predetermined bit correlation x₀, 0.5<x₀<1, said method comprising the steps of:
i. conducting steps a) to f) of claim 1 to construct a first and second string K_{A} and K_{B} having bit correlation x>0.5;
ii. if x<x₀, repeatedly conducting steps a) to f) of claim 1 until the bit correlation x=x(K_{A},K_{B}) is greater than or equal to x₀; and
iii. if x>x₀, replacing K_{A}, K_{B} by a first and second concatenated string U=R_{A}K_{A} and V=R_{B}K_{B}, respectively, wherein R_{A} and R_{B} is a first and second random string generated in first and second station A and B, respectively, each having a length which ensures that the bit correlation of U and V is equal to x₀.

10. A method of generating a first and second string U and V in a first and second station A and B, respectively, said first and second string having a predetermined bit correlation x₀ in the range of 0<x₀<0.5, said method comprising the steps of:
i. constructing a third and fourth string K_{A}, K_{B} with bit correlation x₁=1−x₀ according to the method of claim 9; and
ii. replacing K_{B} by its Boolean complement K_{B}*, wherein said complement is obtained by replacing 1 and 0 in K_{B} by 0 and 1, respectively.

11. A method of generating a first and second string U and V in a first and second station A and B, respectively, said first and second string U and V having a predetermined bit correlation x₀ in the range 0.5<x₀<1, said method comprising the steps of:
i. conducting steps a) to f) of claim 2 to construct a first and second concatenated string K_{A} and K_{B} having bit correlation x>0.5;
ii. if x<x₀, repeatedly conducting steps a) to f) of claim 2 until the bit correlation x=x(K_{A}, K_{B}) is greater than or equal to x₀; and
iii. if x>x₀, replacing K_{A}, K_{B} by a third and fourth concatenated string U=K_{A} R_{A}, V=K_{B} R_{B}, respectively, where R_{A} and R_{B} is a first and second random string generated in said first and second station A and B, respectively, each said first and second random string having a length which ensures that the bit correlation of U and V is equal to x₀.

12. A method of predicting with arbitrarily high precision the length of an unconditionally secure cryptographic key generated by the method of claim 2, said method comprising the steps of:
i. conducting steps of a) to e) of claim 2 to create first and second concatenated strings K_{A} and K_{B};
ii. calculating the initial bit correlation x(K_{A},K_{B}); and
iii. estimating the length of an unconditionally secure cryptographic key based on this calculated correlation.

13. An unconditionally secure encryption method, said method comprising the steps of:
i. generating first and second unconditionally secure keys Λ(K_{A})=Λ(K_{B}) according to the method of claim 1; and
ii. concatenating said first and second unconditionally secure keys Λ(K_{A}) and Λ(K_{B}) to generate a one-time pad.

14. A complete cryptographic system, comprising:
a standard Kerberos configuration,
wherein a server authenticates a plurality of communicating parties and said parties generate an unconditionally secure cryptographic key according to the method of claim 1.

15. A complete cryptographic system, comprising:
an unconditionally secure key generated by claim 1; and
an authentication algorithm.

16. The method of claim 1, wherein all strings are binary strings.

17. The method of claim 1, wherein the function f maps a non-null string to that same string with the last element deleted.

18. The method of claim 1, wherein:
the alphabet is a finite abelian group G; and
the function Γ maps a string over G to the sum of the elements in the string.

19. The method of claim 17 wherein G is the binary field and Γ maps a string to its parity.

20. The method of claim 1, wherein the function Γ maps all strings to a given fixed string such that for any two strings X and Y, Γ(X)=Γ(Y).

21. The method of claim 1, wherein:
for a binary string U of length l≧1, f(U)=parity of U; and
for a first and second substring X and Y of L_{A} and L_{B}, respectively, Γ(X)=Γ(Y) such that Pₗ(X,Y)=(parity(X),parity(Y)).

22. The method of claim 1 wherein:
f maps a non-null string to that same string with the last element deleted;
Γ maps a binary sting to its parity; and the strings U₁(=S_{A}), U₂, . . . , Uₘ; and
Vₗ(=S_{B}), V₂, . . . , Vₘ all have a common length 1.

23. The method of claim 1, wherein:
all strings are over the alphabet G, wherein G is a finite abelian group;
in step a) said strings L_{A} and L_{B} are replaced by L_{A}+R_{A},L_{B}+R_{B}, R_{A} and R_{B} being a first and second random string over G of the same length as L_{A} and L_{B} and +denoting component-wise addition over G.

24. The method of claim 1, wherein:
for each i, 1≦i≦m, f and Γ are predefined on all substrings of all iterates f(Uᵢ), f(f(Uᵢ)), f(f(f(Uᵢ))), . . . and f(Vᵢ), f(f(Vᵢ)), f(f(f(Vᵢ))), . . . ;
f, Γ map the null string to the null string; and
f maps all strings of length 1 to the null string.

25. The method of claim 1, wherein in step a) the physical phenomena comprises measurement by said first station A of a plurality of message round-trip times from said first station A to second station B, and measurement by said second station B of a plurality of message round-trip times from said second station B to said first station A.

26. The method of claim 1, wherein in step a) the physical phenomenon comprises a common signal emanating from an outside transmitting source selected from at least one of a satellite, a group of satellites, a radio transmitter, and a group of radio transmitters.

27. The method of claim 1, wherein S of step g) is the inequality n(1−x)<ε where ε is a pre-determined positive number.

28. The method of claim 1, wherein λ is a pre-determined fraction of t, said fraction lying in the range between 0 and 1.

29. A method for verifying with pre-determined probability equality of a first string S₁ in a first station A with a second string S₂ in a second station B, S₁ and S₂ having the same length, said method comprising the steps of:
i. conducting steps a) to i) of the method of claim 2 wherein R₁=S₁ and R₂=S₂; and
ii. conducting steps b) to f) of the method of claim 2 if C(K_{A})≠C(K_{B}).

30. A method for determining the correlation between a first secret string U in a first station A and a second secret string V in a second station B, said method comprising the steps of conducting steps a) through i) of the method of claim 2 wherein R₁=U and R₂=V.

31. A method for checking the equality of a first and second key U and V in a first and second station A and B, respectively, comprising the steps of:
obtaining said first and second key U and V, respectively, from a public key exchange algorithm used between said first and second; and
conducting the method of claim 28 wherein S1=U and S₂=V.
